(19) United States
(12) Patent Application Publication
(10) Pub. No.: US 2016/0236736 A1
(43) Pub. Date: Aug. 18, 2016

(54) LINK ASSEMBLY FOR A MACHINE

(71) Applicant: Caterpillar Inc., Peoria, IL (US)

(72) Inventors: Timothy A. Thorson, Morton, IL (US); Ajay D. Yadav, Aurora, IL (US); Gregory J. Kaufmann, Metamora, IL (US); Robert L. Meyer, Metamora, IL (US); Mark S. Diekevers, Germantown Hills, IL (US); Angela M. LaMere, Pekin, IL (US); Rohit A. Bhapkar, Peoria, IL (US)

(73) Assignee: Caterpillar Inc., Peoria, IL (US)

(21) Appl. No.: 14/623,712

(22) Filed: Feb. 17, 2015

(51) Int. Cl. B62D 55/21; B62D 55/26

(52) U.S. Cl. CPC B62D 55/21; B62D 55/26

(57) ABSTRACT

A link assembly for a track-type machine is disclosed. The link assembly includes a plurality of laterally spaced pairs of track links and a plurality of track shoes engaged with the corresponding pairs of track links. Each track link includes an elongate body having a first end, a second end distal to the firs end, a shoe face extending between the first end and the second end and one or more protrusions extending from the shoe face. The track shoe includes a base having a top surface, a bottom surface distal to the top surface and apertures extending between the top surface and the bottom surface configured to receive the protrusions therethrough. The protrusions are configured to be deformed to fixedly engage the track shoe with the track link.

### TECHNICAL FIELD

The present disclosure relates to a tracked undercarriage system for a machine, and more particularly relates to a link assembly of the tracked undercarriage system.

### BACKGROUND

Machines, such as excavators may include a tracked undercarriage system for providing traction between ground surface and the machine. The undercarriage system includes a roller track frame having various guiding components to support a link assembly. The link assembly moves over the roller track frame relative to the guiding components to move the machine. The link assembly includes an endless track link assembly which slides over the roller track frame with the help of the guiding components. The track link assembly includes multiple pairs of track links. The link assembly further includes multiple track shoes corresponding to the multiple pairs of track links. The track shoes engage with the ground surface. Further, the track shoes are generally coupled to the pairs of track links via bolts and nuts. The bolts and nuts may loosen over a time, and hence the track shoe may be disconnected from the track link. Further, high tolerance requirements for bolted joints make design of the link assembly complex and cost intensive. Additionally, assembly of the track shoes with the pairs of track links may require increased time and effort.

US Patent Publication Number 2014/0001827 discloses an undercarriage assembly. The undercarriage assembly includes a link assembly having a plurality of laterally spaced pairs of track links pivotally connected to one another at pivot joints to form an endless chain. The undercarriage assembly may also include an idler. The idler includes a solid disk with substantially planar sides and an outer tread surface engaging an inner portion of the endless chain.

### SUMMARY OF THE DISCLOSURE

In one aspect of the present disclosure, a link assembly for a track-type machine is provided. The link assembly includes a plurality of laterally spaced pairs of track links. Each track link of the pairs of track links includes an elongate body. The elongate body includes a first end and a second end distal to the first end. The elongate body further includes a shoe face extending between the first end and the second end. The elongate body further includes one or more protrusions extending from the shoe face. The link assembly further includes a plurality of track shoes configured to be engaged with the shoe face of the plurality of the pairs of track links. Each of the track shoes includes a base defining a top surface and a bottom surface distal to the top surface. The track shoe further includes one or more apertures extending between the top surface and the bottom surface configured to receive the one or more protrusions therethrough. The protrusions are configured to be deformed to fixedly engage the track shoe with the track link and further the bottom surface of the base abuts the shoe face of the track link.

In another aspect of the present disclosure, a link assembly for a track-type machine is provided. The link assembly includes a track shoe having a base. The base includes a top surface and a bottom surface distal to the top surface. The link assembly further includes a pair of track links laterally disposed with respect to each other. Each of the pair of track links includes a shoe face configured to abut the bottom surface of the track shoe. The link assembly further includes a retaining member disposed on the bottom surface of the track shoe and disposed between each track link of the pair of track links. The retaining member has a first end and a second end adjacent to a corresponding track link of the pair of track links. The first end and the second end of the retaining member are configured to be deformed to fixedly engage with the corresponding track link of the pair of track links.

In yet another aspect of the present disclosure, a link assembly for a track-type machine is provided. The link assembly includes a plurality of laterally spaced pairs of track links. Each track link of the pairs of track links includes an elongate body. The elongate body includes a first end and a second end distal to the first end. The elongate body further includes a shoe face extending between the first end and the second end. The elongate body further includes a protrusion extending from the shoe face. The protrusion includes a first leg member and a second leg member extending from the shoe face and defines a slot therebetween. The protrusion further includes a head member disposed adjacent to the first leg member and the second leg member. The head member has a diameter. The link assembly further includes a plurality of track shoes configured to be engaged with the shoe face of the plurality of the pairs of track links. Each of the track shoes includes a base defining a top surface and a bottom surface distal to the top surface. The track shoe further includes an aperture extending between the top surface and the bottom surface. The aperture is configured to receive the protrusion therethrough. The aperture defines a second diameter that is less than the first diameter of the head member. The first leg member and the second leg member are deflected to be received through the aperture. The head member of the first leg member and the second leg member is configured to engage the track shoe with the track link.

Other features and aspects of this disclosure will be apparent from the following description and the accompanying drawings.

### BRIEF DESCRIPTION OF THE DRAWINGS

FIG. 1 is a side view of a machine having an undercarriage system with a link assembly, according to an embodiment of the present disclosure;

FIG. 2 is a perspective view of a portion of the link assembly of FIG. 1, according to an embodiment of the present disclosure;

FIG. 3 is a perspective view of multiple pairs of track links of the link assembly, according to an embodiment of the present disclosure;

FIG. 4 is a perspective view of a track shoe of the link assembly, according to an embodiment of the present disclosure;

FIG. 5 is a sectional view taken along line X-X′ of FIG. 2, according to an embodiment of the present disclosure;

FIG. 6 is a sectional view taken along line Y-Y′ of FIG. 2, according to an embodiment of the present disclosure;

FIG. 7 is a perspective view of the track link, according to another embodiment of the present disclosure; and

FIG. 8 is a sectional view showing the track link and the track shoe, according to yet another embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

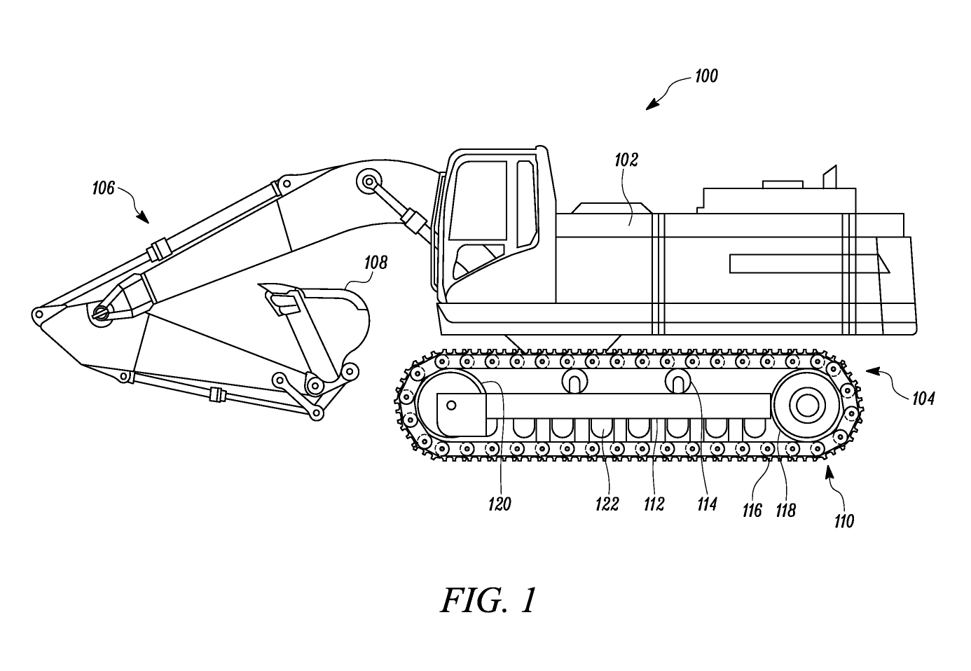

FIG. 1 shows a side view of a machine 100. In the illustrated embodiment, the machine 100 is an excavator having a tracked undercarriage system. However, the machine 100 may be any other type of machine used in various industries, such as mining, construction, and the like, and having a tracked undercarriage system. The machine 100 includes a body 102 rotatably supported on a chassis 104. An implement 106, including a bucket 108, is coupled to the body 102. The bucket 108 may be used for performing various operations, such as excavation, dumping and loading. The machine 100 further includes an undercarriage system 110 coupled to the chassis 104. The undercarriage system 110 may be used for supporting the body 102 and for moving the machine 100 along a ground surface. The undercarriage system 110 includes a track roller frame 112. Further, one or more guiding components, such as the guiding component 114, may be connected to the track roller frame 112. The undercarriage system 110 further includes a link assembly 116 configured to be moved over the track roller frame 112 relative to the guiding components 114. The undercarriage system 110 further includes a drive sprocket 118 to receive power from a power source, such as an engine (not shown), and to drive the link assembly 116 relative to an idler 120. A plurality of rollers 122 and a plurality of guiding components 114 may be used for assisting movement of the link assembly 116 over the track roller frame 112.

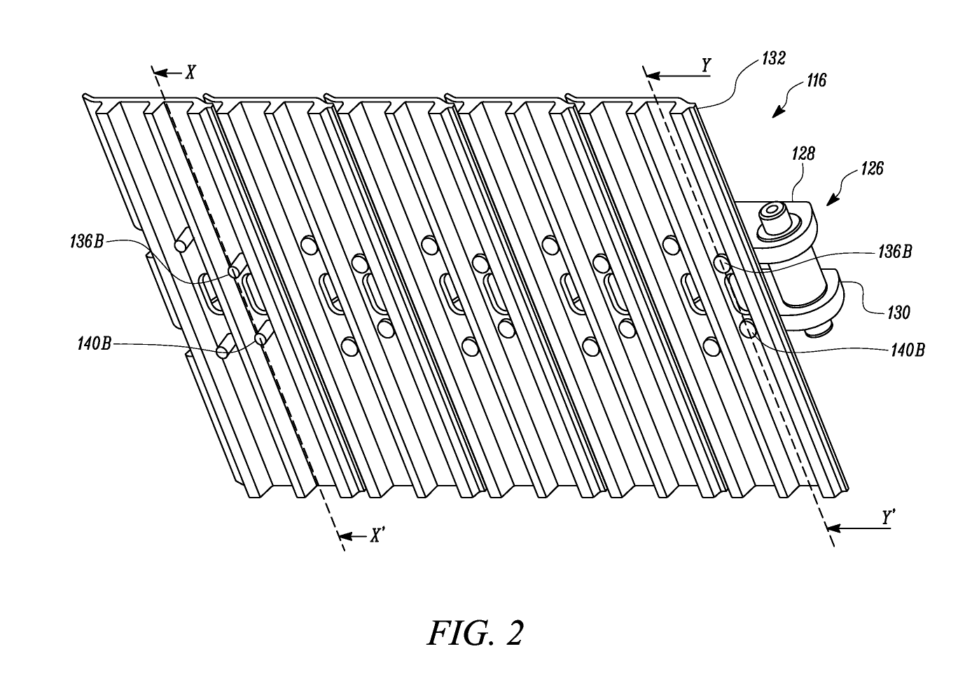

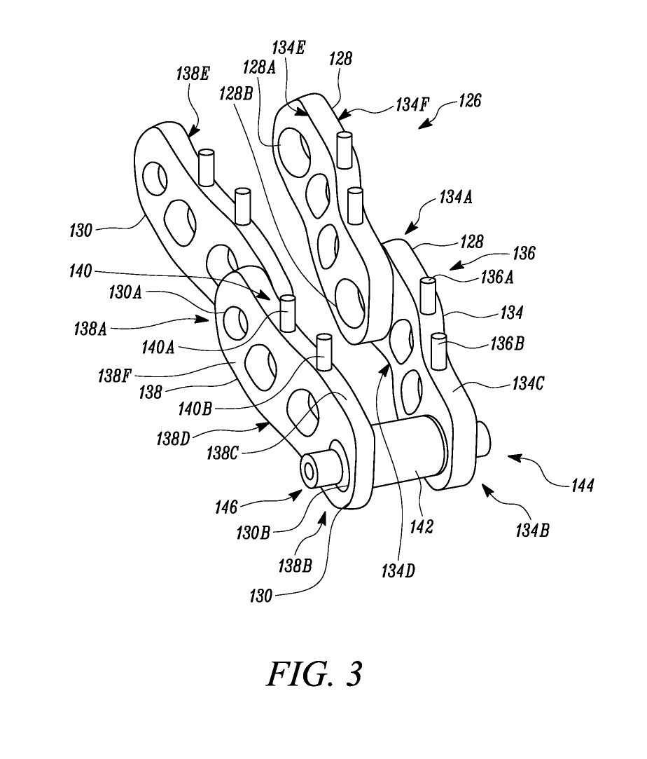

FIG. 2 shows a perspective view of a portion of the link assembly 116. Referring to FIGS. 1 and 2, the link assembly 116 includes a plurality of laterally spaced pairs of track links 126 configured to be slidably engaged with the guiding components 114 of the track roller frame 112. Each pair of track links 126 includes a first track link 128 and a second track link 130 disposed laterally to the first track link 128. The first and the second track links 128, 130 are described in detail later with reference to FIG. 3. The link assembly 116 further includes a plurality of track shoes 132. Each of the plurality of track shoes 132 is configured to be engaged with each pair of track links 126. Further, the plurality of track shoes 132 may be configured to engage with the ground surface to provide traction between the machine 100 and the ground surface. Thus, the plurality of the pairs of track links 126 and the plurality of the track shoes 132 together may form endless link assembly 116 to slidably engage with the guiding components 114 of the track roller frame 112. The plurality of track shoes 132 may move along with the plurality of the pairs of track links 126 to propel the machine 100 along the ground surface.

FIG. 3 shows a perspective view of multiple pairs of track links 126, according to an embodiment of the present disclosure. In FIG. 3, two pairs of track links 126 of a plate type offset track link assembly are shown for illustration purpose of the present disclosure. Further, the first track link 128 is illustrated in detail below. The first track link 128 includes an elongate body 134. The elongate body 134 includes a first end 134A and a second end 134B distal to the first end 134A. The elongate body 134 further includes a shoe face 134C extending between the first and the second ends 134A, 134B. The shoe face 134C is configured to engage with the track shoe 132. Further, the elongate body 134 includes a roller face 134D distal to the shoe face 134C and extending between the first and the second ends 134A, 134B. As shown in FIG. 1, the roller face 134D may be configured to slidably engage with the guiding components 114 of the track roller frame 112. The elongate body 134 further includes a first side surface 134E and a second side surface 134F distal to the first side surface 134E. The first track link 128 further defines a first opening 128A and a second opening 128B extending between the first and the second side surfaces 134E, 134F and adjacent to the first and the second ends 134A, 134B, respectively.

The elongate body 134 further includes one or more protrusions 136 extending from the shoe face 134C. The protrusions 136 are configured to engage the track shoe 132 with the track link 126. In the illustrated embodiment, the elongate body 134 includes a first protrusion 136A extending from the shoe face 134C adjacent to the first end 134A. The elongate body 134 further includes a second protrusion 136B extending from the shoe face 134C adjacent to the second end 134B. However, it may be contemplated that the elongate body 134 may include any number of protrusions 136 to engage the track shoe 132 with the track link 126. In an embodiment, the first protrusion 136A and the second protrusion 136B are integrally formed with the elongate body 134 of the first track link 128. In an alternative embodiment, the first and the second protrusions 136A, 136B may be a separate part. In such a case, the first track link 128 may include a pair of holes defined on the shoe face 134C to engage with the first and the second protrusions 136A, 136B. Further, the first protrusion 136A and the second protrusion 136B extend vertically from the shoe face 134C.

Similar to the first track link 128, the second track link 130 includes an elongate body 138 having a first end 138A, a second end 138B, a shoe face 138C, a roller face 138D, a first side surface 138E and a second side surface 138F. Further, the second track link 130 includes a first opening 130A and a second opening 130B. The elongate body 138 also includes protrusions 140, such as a first protrusion 140A and a second protrusion 140B. The above described construction of the first and second track links 128, 130 is exemplary.

In various examples, the link assembly 116 may include a forged offset track link assembly, a forged inline track link assembly and a plate type inline track link assembly. In the forged offset and inline track link assemblies, the first and second protrusions 136A, 136B, 140A, 140B may be integrally forged with the elongate bodies 134, 138 of each of the track links 128, 130, respectively, of the pair of track links 126.

In the illustrated embodiment, each of the protrusions 136, 140 may have a circular cross section defining a diameter. In various embodiments, the cross section of the protrusions 136, 140 may be a square, a rectangular, an elliptical or a polygonal shape.

In an exemplary embodiment, a method of assembling the plate type offset track link assembly is described in detail for illustration purpose of the present disclosure. Each pair of track links 126 includes a pin member 142 having a first end 144 and a second end 146 distal to the first end 144. Each of the first end 144 and the second end 146 includes a first diameter portion (not shown) and a second diameter portion (not shown) adjacent to the first diameter portion. The first diameter portions at the first and the second ends 144, 146 of the pin member 142 may be configured to engage with the second openings 128B, 130B of the first and the second track links 128, 130, respectively.

During assembly of the pair of track links 126, the first track link 128 and the second track link 130 may be laterally spaced adjacent to the first and second ends 144, 146, respectively, of the pin member 142. Further, the pin member 142 may be co-axially aligned with the second openings 128B, 130B. The first track link 128 and the second track link 130 may be moved towards each other to engage with the first diameter portions of the first and the second ends 144, 146, respectively, of the pin member 142. The first openings 128A, 130A of the first and the second track links 128, 130 of another pair of track links 126 may be pivotally engaged with the second diameter portions at the first and second ends 144, 146, respectively, of the pin member 142. Thus, the pair of track links 126 may pivotally move relative to the adjacent pair of track links 126 about the pin member 142. Thus, each of the pair of track links 126 of the link assembly 116 pivotally move relative to the adjacent pair of track links 126 about the corresponding pin member 142.

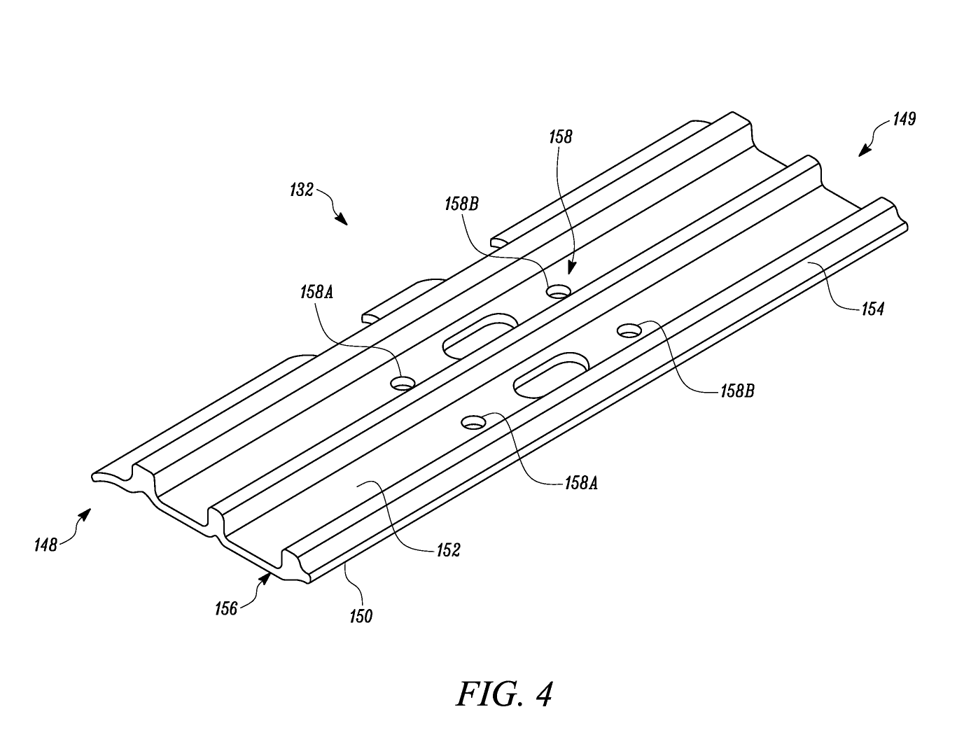

FIG. 4 shows a perspective view of exemplary track shoe 132. The track shoe 132 is an elongate body extending between a first end 148 and a second end 149. The track shoe 132 includes a base 150 having a top surface 152 extending between the first and the second ends 148, 149. The top surface 152 includes a plurality of leg members 154 extending between the first and the second ends 148, 149 configured to engage with the ground surface. Further, the track shoe 132 includes a bottom surface 156 distal to the top surface 152. The bottom surface 156 is configured to abut the shoe faces 134C, 138C of the first and the second track links 128, 130, respectively. The track shoe 132 further includes one or more apertures 158 extending between the top and the bottom surfaces 152, 156. In the illustrated embodiment, the track shoe 132 includes a first set of apertures 158A and a second set of apertures 158B. The first and second set of apertures 158A, 158B may be laterally spaced with respect to each other. Each of the apertures 158 may have a diameter greater than the diameter of each of the protrusions 136, 140 to receive corresponding protrusion of the set of protrusions 136, 140. In an example, the first set of apertures 158A may be configured to receive the first and the second protrusions 136A, 136B of the first track link 128. Similarly, the second set of apertures 158B may be configured to receive the first and the second protrusions 140A, 140B of the second track link 130. The above described construction of the track shoe 132 is exemplary, and it may be contemplated that any known type of track shoes may be provided with the first and second set of apertures 158A, 158B to receive the protrusions 136, 140, respectively.

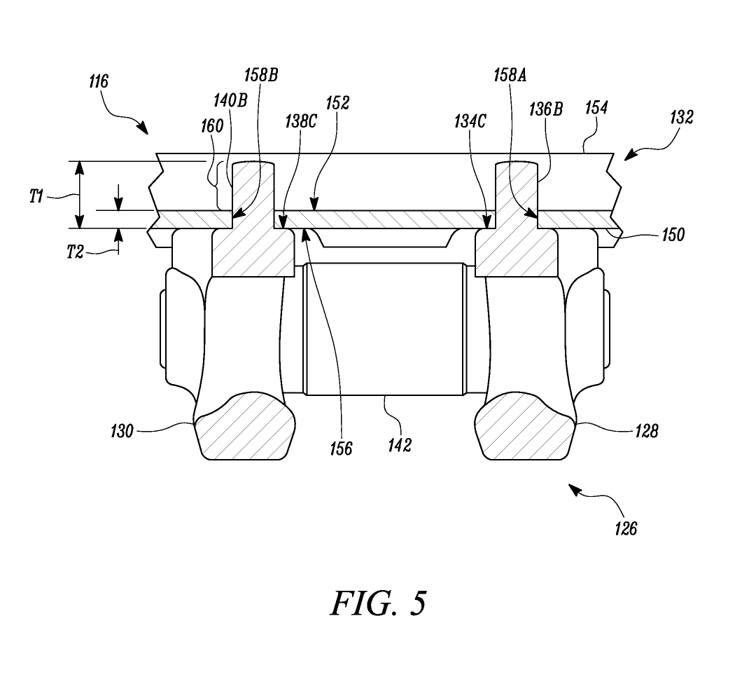

FIG. 5 shows a sectional view taken along line X-X′ of FIG. 2, according to an embodiment of the present disclosure. Referring to FIG. 2, the first protrusions 136B, 140B of one of the pairs of track links 126 are shown in a deformed condition for illustration purpose of the present disclosure. During an assembly of the track shoe 132 with the pair of track links 126, the first and the second set of apertures 158A, 158B may be aligned with the set of protrusions 136, 140, respectively. Further, the track shoe 132 may be disposed on the pair of track links 126 such that the bottom surface 156 of the base 150 abut the shoe faces 134C, 138C of the first and the second track links 128, 130, respectively. Referring to FIGS. 2 and 5, each of the set of protrusions 136, 140, has a thickness ‘T1’ greater than a thickness ‘T2’ defined between the top and the bottom surfaces 152, 156 of the base 150 of the track shoe 132. Further, a portion 160 of each of the set of protrusions 136, 140 projects above the top surface 152 of the base 150. In FIG. 5, only the portions 160 of the first protrusions 136B, 140B are shown for illustrative purposes.

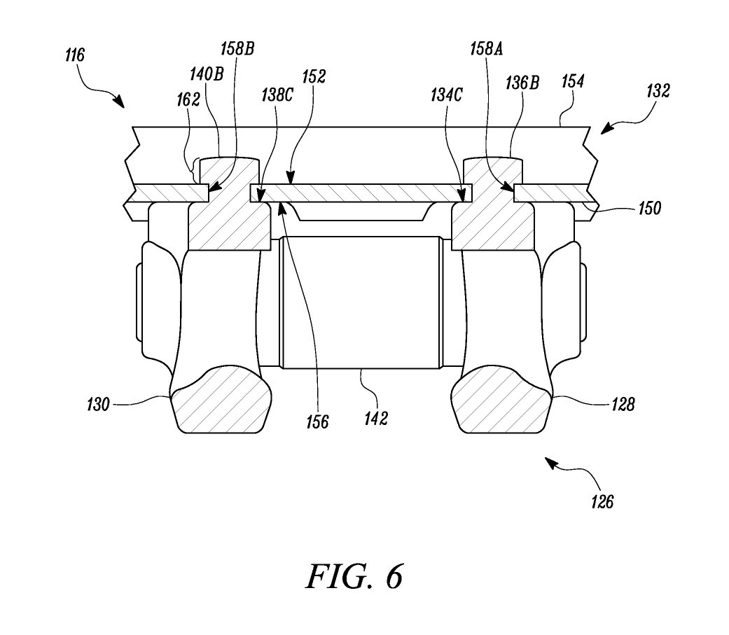

FIG. 6 shows a sectional view taken along line Y-Y′ of FIG. 2, according to an embodiment of the present disclosure. The portion 160 of each of the set of protrusions 136, 140 is deformed to define a deformed portion 162 having a diameter greater than the diameter of the apertures 158. In FIG. 6, only the deformed portions 162 of first protrusions 136B, 140B are shown. The deformed portion 162 of each of the set of protrusions 136, 140 may be configured to fixedly engage the track shoe 132 with the track link 126. In a deformed condition of the set of protrusions 136, 140, the bottom surface 156 of the base 150 abuts the shoe faces 134C, 138C of the first and the second track links 128, 130, respectively. Similarly, the set of protrusions 136, 140 of each pair of the plurality of pairs of track links 126 may be deformed to fixedly engage with the corresponding track shoe 132.

In an embodiment, the portion 160 of the each of the set of protrusions 136, 140 is deformed to the deformed portion 162 by a hot upset forming process. In an example, the hot forming process may use heat and pressure to engage the track shoe 132 with the pair of track links 126. Machine used for the hot upset forming process may heat the portion 160 of each of the set of protrusions 136, 140 to make the portions 160 malleable. Further, a pressure may be applied on the heated portion to form the deformed portion 162, thereby engaging the track shoe 132 with the pair of track links 126. In another embodiment, the portions 160 may be deformed by press forming using a pressing machine, such as a hydraulic press.

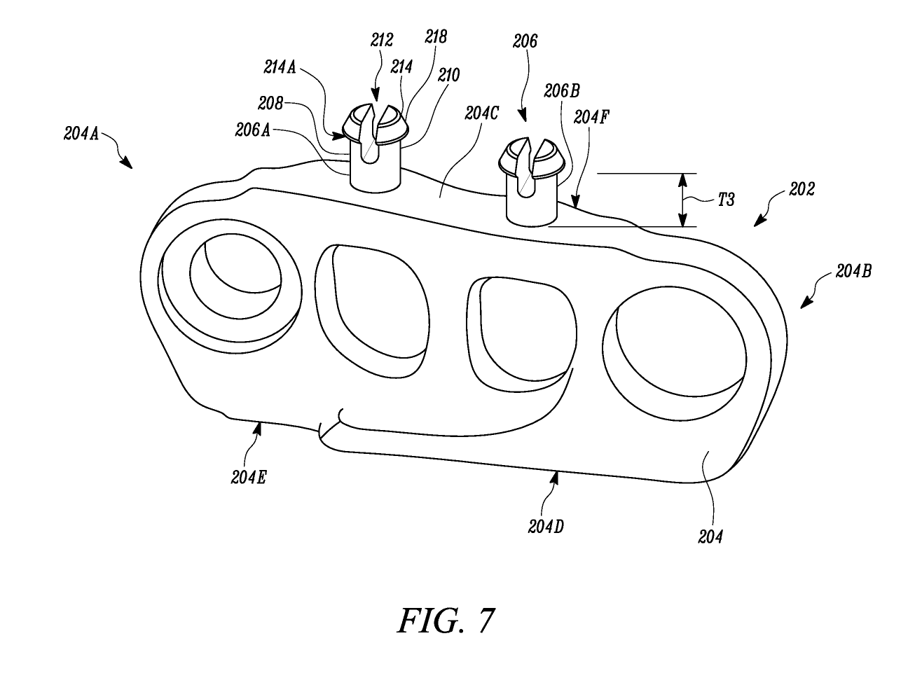

FIG. 7 shows a perspective view of a track link 202, according to another embodiment of the present disclosure. Similar to the first track link 128, the track link 202 includes an elongate body 204 having a first end 204A, a second end 204B, a shoe face 204C, a roller face 204D, a first side surface 204E and a second side surface 204F. Further, the track link 202 includes a first opening 202A and a second opening 202B.

The elongate body 204 further includes one or more protrusions 206 extending from the shoe face 204C. The protrusions 206 are configured to engage the track shoe 132 with the track link 202. In the illustrated embodiment, the elongate body 204 includes a first protrusion 206A extending from the shoe face 204C adjacent to the first end 204A of the elongate body 204. The elongate body 204 also includes a second protrusion 206B extending from the shoe face 204C adjacent to the second end 204B of the elongate body 204. However, it may be contemplated that the elongate body 204 may include any number of protrusions 206 to engage the track shoe 132 with the track link 202. The first protrusion 206A and the second protrusion 206B are integrally formed with the elongate body 204 of the track link 202. Further, the first protrusion 206A and the second protrusion 206B extend vertically from the shoe face 204C. In various embodiments, the first and second protrusions 206A, 206B may be integrally formed with a track link associated with the forged offset and inline track link assemblies and the plate type inline track link assembly.

Referring to FIG. 7, the first protrusion 206A is described in detail for illustration purpose of the present disclosure. The first protrusion 206A includes a first leg member 208 and a second leg member 210. The first and the second leg members 208, 210 define a slot 212 therebetween. The slot 212 may allow the first and the second leg members 208, 210 to deflect towards each other. A head member 214 is disposed adjacent to each of the first and the second leg members 208, 210. The head member 214 may have a diameter greater than the diameter of the apertures 158. Further, the first protrusion 206A may have a circular cross section between the shoe face 204C and an inner face 214A of the head member 214. The first protrusion 206A further defining a diameter less than the diameter of the apertures 158. The head member 214 may further include a tapered portion 218 defined at a periphery adjacent to a top face opposite to the inner face 214A. Each of the first and the second protrusions 206A, 206B define a thickness ‘T3’ between the shoe face 204C and the inner face 214A of the head member 214. The thickness ‘T3’ is equal to or greater than the thickness ‘T2’ of the base 150 of the track shoe 132.

During assembly of the track shoe 132 with each of the pair of track links 202, the set of apertures 158A, 158B of the track shoes 132 may be aligned with the set of protrusions 206 of each track link 202. The tapered portion 218 may facilitate the track shoe 132 to move towards the shoe face 204C of the track link 202. Further, the first and the second leg members 208, 210 may deflect towards each other to pass through each of the corresponding apertures 158. The bottom surface 156 of the track shoe 132 further abuts the shoe face 204C of the track link 202 and the inner face 214A of the head member 214 abuts the top surface 152 of the track shoe 132. Thus, the head members 214 of the first and the second leg members 208, 210 are configured to engage the track shoe 132 with the track link 202.

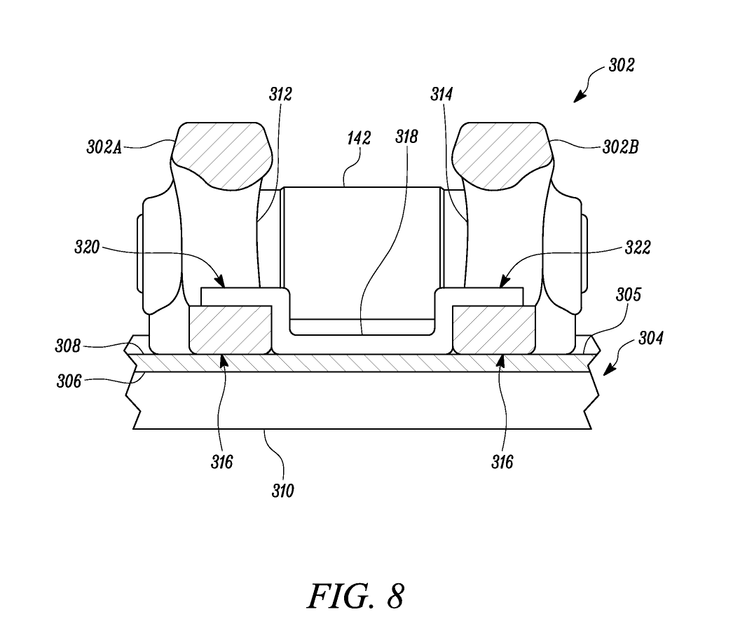

FIG. 8 shows a sectional view illustrating a pair of track links 302 and a track shoe 304, according to yet another embodiment of the present disclosure. The pair of track links 302 associated with the plate type offset track link assembly is illustrated in detail for illustration purpose. The track shoe 304 includes a base 305 having a top surface 306 and a bottom surface 308. The pair of track links 302 includes a first track link 302A and a second track link 302B. The first and the second track links 302A, 302B are laterally disposed with respect to each other. Further, each of the first and the second track links 302A, 302B includes a shoe face 316. The shoe faces 316 are configured to abut the bottom surface 308 of the track shoe 304. As shown in FIG. 8, the track shoe 304 includes a retaining member 318 disposed on the bottom surface 308 thereof. In an embodiment, the retaining member 318 is integrally formed with the base 305 of the track shoe 304. In an alternative embodiment, the retaining member 318 may be a separate component coupled to the bottom surface 308 of the base 305. The retaining member 318 is further configured to be disposed between the first and the second track links 302A, 302B.

The retaining member 318 further includes a first end 320 and a second end 322. As shown in FIG. 1, the first and the second ends 320, 322 are configured to engage with the first and the second track links 302A, 302B, respectively. Further, each of the first and the second ends 320, 322 of the retaining member 318 is configured to form a curvilinear shape to engage with the corresponding first and the second track links 302A, 302B of each pair of the plurality of pairs of track links 302.

In an embodiment, the first track link 302 includes a side surface 312 and the second track link 302B includes a side surface 314 facing the side surface 312 of the first track link 302A. The side surfaces 312, 314 of the first and the second track links 302A, 302B are configured to engage with the first and the second ends 320, 322, respectively, of the retaining member 318.

During assembly of the pair of track links 302 with the track shoe 304, the first and the second track links 302A, 302B may be disposed on the bottom surface 308 of the base 305 adjacent to the first and the second ends 320, 322, respectively, of the retaining member 318. Further, the side surfaces 312, 314 of the first and the second track links 302A, 302B may face each other. The first and the second track links 302A, 302B may be moved towards the first and the second ends 320, 322 of the retaining member 318 relative to the bottom surface 308 of the base 305. The first and the second ends 320, 322 of the retaining member 318 deform to fixedly engage with the corresponding first and the second track links 302A, 302B. Thus, each pairs of the plurality of track links 302 may be engaged with the retaining member 318 disposed on the corresponding track shoe 304. In various embodiments, the pair of track links 302 may be associated with the forged offset and inline track link assemblies and the plate type inline track link assembly.

### INDUSTRIAL APPLICABILITY

The present disclosure relates to the link assembly 116 in which each pair of the multiple pairs of track links may be engaged with the corresponding multiple track shoe via integral members. In an embodiment, the integral member includes the set of protrusions 136, 140 of the first and the second track links 128, 130 of the pair of track links 126. In another embodiment, the integral member includes the set of protrusions 206 of the track link 202. In yet another embodiment, the integral member includes the retaining member 318 of the track shoe 304.

As the track links 126, 202, 302 and the track shoes 132, 304, are engaged with each other via the corresponding integral members formed with either the track link or the track shoe, the coupling between the track shoe and the track link may become robust and reliable. Time and effort required for assembling the track links and the track shoe may be reduced compared to the existing assemblies with bolts and nuts. Complexity in design and manufacture of the track links and the track shoe may also be reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A link assembly for a track-type machine, the link assembly comprising:
a plurality of laterally spaced pairs of track links, each of the pairs of track links having an elongate body, the elongate body comprising:
a first end and a second end distal to the first end;
a shoe face extending between the first end and the second end; and
one or more protrusions extending from the shoe face; and
a plurality of track shoes configured to be engaged with the shoe face of the plurality of the pairs of track links, each of the track shoes comprising:
a base defining a top surface and a bottom surface distal to the top surface; and
one or more apertures extending between the top surface and the bottom surface configured to receive the one or more protrusions therethrough;
wherein the protrusions are configured to be deformed to fixedly engage the track shoe with the track link, and wherein the bottom surface of the base abuts the shoe face of the track link.

2. The link assembly of claim 1, wherein the one or more protrusions are integrally formed with the elongate body of the track link.

3. The link assembly of claim 1, wherein the one or more protrusions extend vertically from the shoe face.

4. The link assembly of claim 1, wherein the elongate body comprising:
a first protrusion extending from the shoe face adjacent to the first end of the elongate body; and
a second protrusion extending from the shoe face adjacent to the second end of the elongate body.

5. The link assembly of claim 4, wherein each of the first protrusion and the second protrusion define a thickness greater than a thickness defined between the top surface and the bottom surface of the base of the track shoe.

6. The link assembly of claim 5, wherein a portion of each of the first protrusion and the second protrusion projecting above the top surface of the base of the track shoe has a diameter greater than a diameter of the aperture.

7. The link assembly of claim 1, wherein the portion is deformed by a hot upset forming process.

8. The link assembly of claim 1, wherein the portion is deformed by press forming.

9. A link assembly for a track-type machine, the link assembly comprising:
a track shoe comprising a base having a top surface and a bottom surface distal to the top surface;
a pair of track links laterally disposed with respect to each other, each of the pair of track links comprising a shoe face configured to abut the bottom surface of the track shoe; and
a retaining member disposed on the bottom surface of the track shoe and disposed between each track link of the pair of track links, the retaining member having a first end and a second end adjacent to a corresponding track link of the pair of track links;
wherein the first end and the second end of the retaining member is configured to be deformed to fixedly engage with the corresponding track link of the pair of track links.

10. The link assembly of claim 9, wherein the retaining member is integrally formed with the base of the track shoe.

11. The link assembly of claim 9, wherein each of the first end and the second end of the retaining member is configured to form a curvilinear shape to engage with the corresponding track link of the pair of track links.

12. The link assembly of claim 9, wherein each track link of the pair of track links comprises a side surface configured to engage with the corresponding first end and the second end of the retaining member.

13. A link assembly for a track-type machine, the link assembly comprising:
a plurality of laterally spaced pairs of track links, each of the pairs of track links having an elongate body, the elongate body comprising:
a first end and a second end distal to the first end;
a shoe face extending between the first end and the second end; and
a protrusions extending from the shoe face, the protrusion comprising;
a first leg member and a second leg member extending from the shoe face and defining a slot therebetween; and
a head member disposed adjacent to the first leg member and the second leg member, the head member having a diameter; and
a plurality of track shoes configured to be engaged with the shoe face of the plurality of the pairs of track links, each of the track shoes comprising:
a base defining a top surface and a bottom surface distal to the top surface; and
an aperture extending between the top surface and the bottom surface, the aperture configured to receive the protrusions therethrough, the aperture defining a second diameter less than the first diameter of the head member;
wherein the first leg member and the second leg member are deflected to be received through the aperture, and wherein the head member of the first leg member and the second leg member is configured to engage the track shoe with the track link.

14. The link assembly of claim 13, wherein the protrusion is integrally formed with the elongate body of the track link.

15. The link assembly of claim 13, wherein the protrusion extends vertically from the shoe face.

16. The link assembly of claim 13, wherein the elongate body comprising:
a first protrusion extending from the shoe face adjacent to the first end of the elongate body; and
a second protrusion extending from the shoe face adjacent to the second end of the elongate body.

17. The link assembly of claim 16, wherein the first protrusion and the second protrusion define a thickness between the shoe face and an inner face of the head member, and wherein the thickness is equal to or greater than a thickness defined between the top surface and the bottom surface of the base of the track shoe.

18. The link assembly of claim 13, wherein the inner face of the head member is configured to abut the top surface of the track shoe.

19. The link assembly of claim 13, wherein the bottom surface of the track shoe abuts the shoe face of the track link.
